(19) United States
(12) Patent Application Publication
(10) Pub. No.: US 2014/0122343 A1
(43) Pub. Date: May 1, 2014

(54) MALWARE DETECTION DRIVEN USER AUTHENTICATION AND TRANSACTION AUTHORIZATION

(71) Applicant: Symantec Corporation, Mountain View, CA (US)

(72) Inventors: Yohai EINAV, Los Gatos, CA (US); Shrevans Mehta, Fremont, CA (US)

(73) Assignee: Symantec Corporation, Mountain View, CA (US)

(21) Appl. No.: 13/666,770

(22) Filed: Nov. 1, 2012

(51) Int. Cl. G06Q 20/00

(52) U.S. Cl. 705/67

(57) ABSTRACT

Techniques are disclosed for detecting online fraud initiated by a host infected with a malicious software application that would otherwise remain undetected by many current fraud detection systems, e.g., for detecting man-in-the-browser Trojans. A fraud detection system operates in conjunction with an IPS system to identify online transactions that have a high probability of being fraudulent or initiated by a legitimate, but compromised host.

### BACKGROUND

1. Field

Embodiments of the invention generally relate to detecting online fraud. More specifically, embodiments presented herein identify online fraud by correlating intrusion protection service (IPS) data with an attempted user authentication or other sensitive online transaction.

2. Description of the Related Art

User authentication, as a means of identifying and verifying a user's identity online, has provided a key tool for combating fraud and unauthorized access to computing systems or online services perpetrated by malware. Malware generally refers to software that disrupts a computers normal operation and performs unauthorized actions. Sometimes, malware simply attempts to spread itself to other systems without disrupting an “infected” host. In other cases, malware may gather sensitive information such as account names, numbers, or passwords used to access an online service or distributed application, e.g., an online banking service or a enterprise system.

While malware, and especially software Trojans (software that looks, and in some cases is, legitimate, but that includes malware components), have become a preferred approach for cyber-criminals, security tools have yet to catch up. Most user authentication and anti-fraud solutions repel attacks by detecting a possible fraud attempt by identifying user or account anomalies, such as an attempt to access a system from a new location or device, or identifying unusual connection characteristics or unknown devices, or unusual transactions. Meanwhile, cyber-criminals have become skilled at how to avoid causing such telltale anomalies.

For example, a relatively new malware technique—referred to as a man-in-the-browser attack—largely compromises these security approaches. A man-in-the-browser works by infecting a web browser, e.g., by taking the advantage of vulnerabilities in browser security to modify certain web pages, modify transaction content or insert additional transactions, all in a completely covert fashion invisible to both the user and host web application. Because this type of attack does not reveal any anomaly, it is often successful regardless of what security mechanisms are in place, e.g., SSL/PKI and/or two or three-factor Authentication. A significant percentage of financial fraud committed today takes advantage of this poorly solved attack. Using an Anti-Virus application to solve this attack is generally also ineffective, since many financial Trojans (e.g., Zeus, SpyEye, Morto, and others) tend to morph quickly, and as a result avoid detection.

### SUMMARY

One embodiment presented herein include a method for detecting attempts at online fraud or unauthorized access to a computing system. This method may generally includes receiving, from a computing device, a request to perform a transaction, and prior to the transaction being performed, determining whether an intrusion prevention system (IPS) has a record of an intrusion attempt occurring on the computing device within a predefined time period prior to receiving the request to perform the transaction. Upon determining the IPS has a record of an intrusion attempt occurring on the computing device within the predefined time period, responding to the request with an indication that the transaction should be challenged

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 illustrates an example computing environment, according to one embodiment.

FIG. 2 illustrates an example of a man-in-the-browser attack, according to one embodiment.

FIG. 3 illustrates a method for an intrusion protection system (IPS) to monitor a host, according to one embodiment.

FIG. 4 illustrates an example structure for IPS database records, according to one embodiment.

FIG. 5 illustrates a method for detecting online fraud by correlating IPS data with a given authentication or transaction attempt, according to one embodiment.

FIG. 6 illustrates an alternative method for detecting online fraud by correlating IPS data with a given authentication or transaction attempt, according to one embodiment.

FIG. 7 illustrates an example computing system configured with an IPS tool and browser plug-in, according to one embodiment.

FIG. 8 illustrates an example computing system 800 configured to identify online transactions that have a high fraud risk, according to one embodiment.

### DETAILED DESCRIPTION

In addition to conventional user-authentication methods (SSL/PKI, 2-factor authentication) a fraud detection system or user authentication system may evaluate a given online transaction before allowing it to proceed. For example, after a user submits a username and password (or other credentials) to an online banking application, the risk assessment application may determine whether to allow access to an account (or whether to allow certain transactions to occur) by evaluating a variety of information related to or about the user or the device making the request. The premise of this approach is that comparing new information about a user or about a device with existing information and looking for something new or unusual is the way to detect unauthorized access. That is, authentication or fraud detection systems assume that when an intruder tries to break into an online account, the intruder would not behave like the legitimate owner. Instead, there would be some anomaly to identify a transaction as being suspicious. For example, the location where a transaction is initiated going to be different or the device used to is going to be different. What attacks such as a man-in-the-browser has shown, however, is that this notion is not always correct.

Embodiments presented herein provide an approach for detecting, and in many cases preventing, online fraud are initiated from a malware infected device that will remain undetected by many current fraud detection systems, e.g., a man-in-the-browser Trojan. In one embodiment, a fraud detection system operates in conjunction with an intrusion prevention system (IPS) to identify online transactions that have a high probability of being fraudulent or initiated by a legitimate, but compromised host. The combined approach allows a financial services company (e.g., a bank, brokerage, etc.) to better vet transactions in real time. More generally, the combined approach allows any system using sign on or authentication process (e.g., cooperate VPN access) to identify authentication transactions that carry a high risk of fraud, based on recent suspicious activity from the system requesting access.

In addition to vetting a user's credentials (and device or transaction data) when authorizing a logon or sensitive transaction, the fraud detection system may determine whether any malware related activities were identified as having recently occurred on a device currently requesting to perform a sensitive transaction (e.g., a transfer of funds from a bank account). This time-based correlation between suspicious activity and sensitive transactions can provide a strong indicator for fraud or unauthorized access. In order to determine whether suspicious has occurred on a device, the fraud detection service may use information stored in an IPS database. For example, a client device may have an IPS software client which provides a proactive security layer configured to monitor network activities on that client device. The IPS software client scans all network traffic and applies protection against a library of vulnerability signatures as well as monitors and logs suspicious events, e.g., when a web-page visited by a user initiates a download on its own.

Compared to traditional antivirus software, which is a reactive technology, IPS provides a proactive protection. Nevertheless, IPS needs to establish a very high confidence threshold before it will block communication to a device or otherwise interrupt network communications. As a result, IPS doesn't have the alertness to block unauthorized access attempts without the context provided by the fraud detection service disclosed herein. However, when, for example, IPS identifies a potential financial Trojan activity on the device on Sunday, and then a sensitive transaction is initiated on Monday, the fraud detection service has enough evidence to block or challenge the transaction initiated on Monday.

In one embodiment, the fraud detection service may evaluate and authorize (or at least recommend whether to proceed with) a transaction. For example, the fraud detection service may be deployed as a cloud service, which processes online banking and enterprise logon transactions to alert on potential risks. In such a case, the banking service may authorize or block certain transactions or require additional verification before allowing a given transaction based on the results of the fraud detection checks. In another embodiment, a client device may include software used to identify sensitive transactions and determine whether an IPS log history indicates that any recent suspicious activity has occurred. For example, a browser plug-in may match an online banking login page or HTML form being accessed by a user. When this occurs, the plug-in may review IPS data to determine whether to allow (or block) a given transaction.

In the following, reference is made to embodiments of the invention. However, the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of the systems) used to provide the computing resources. A user can access any of the resources that reside in the cloud at any time, and from anywhere across the Internet.

In context of the present invention, a cloud based application may be configured to evaluate banking or financial transactions (or other web based transactions) to identify when a given transaction is being requested following a recent indication of suspicious activity. Note, embodiments are described below using an online banking transaction as a reference example of a transaction that may be evaluated by a fraud detection system operating in conjunction with an IPS system. Of course, one of ordinary skill in the art will recognize that embodiments of the invention may readily be adapted to evaluate a broad variety of sensitive transactions conducted over computer networks.

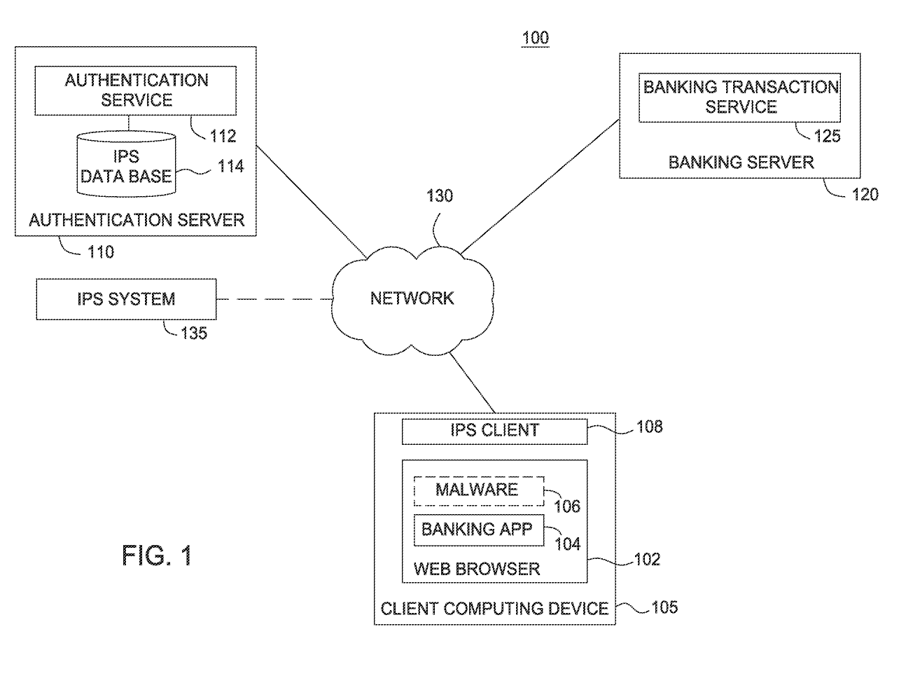

FIG. 1 illustrates an example computing environment 100, according to one embodiment. The computing environment 100 allows an authentication service 112 to recommend whether a banking service 125 should allow a transaction initiated on a client computing device 105 to occur. As shown, the computing environment includes an authentication server 110 hosting an authentication service 112 and IPS database 114 and a banking server 120, each connected to a network 130 (e.g., the internet). Server systems 110 and 120 may be physical computing systems (e.g., a system in a data center) or may be a virtual computing instance executing within a computing cloud. In any event, the banking server 120 hosts a banking transaction service 125 used to provide online banking tools to bank customers. For example, banking transaction service 125 may be implemented as an application server, web server, and a database. Of course, other approaches may be used. In one embodiment, a user accesses the banking transaction service 125 using a web browser 102. For example, banking application 104 may includes a collection of static and dynamically generated web pages, forms, images, scripts, and images, etc., downloaded from banking transaction service 125 and rendered by the browser 102.

As shown, client computing device 105 includes an IPS client 108. The IPS client 108 provides a software application configured to monitor network communications and other activity occurring on the client device 105 for signs suspicious or malicious activity. For example, the IPS client 108 may be configured to identify signatures associated with a given exploit in network packets sent to/from the client device 105. Similarly, the IPS client 108 may evaluate statistical patterns of network activity to identify when anomalous or suspicious events occur. When the IPS client 108 identifies suspicious activity, it may send a description of that activity to IPS database 114 (as well as store information in log on device 105). Frequently, the suspicious activity may be insufficient for the IPS client 108 to block or interrupt activity on the client device 105. For example, assume a user visits a site hosting malware downloaded to client device 105 simply by accessing the site—sometimes referred to as a “drive-by download.” In such a case, the IPS client 108 may observe a download not directly initiated by the user and flag this activity as suspicious or as being a possible intrusion attempt. In other cases, the IPS client 105 may observe network payloads, addresses, or other information indicative of malicious activity. While the IPS client 108 might not interrupt such download or be able to identify a malware signature in the network communications, it can log the occurrence of suspicious activity locally and send a record of the activity to the IPS database 114. IPS client 108 may send a specific machine ID associated with client computing device 105 to the IPS database 114.

In another embodiment, the client device 105 might not have IPS client 108 installed locally. In such cases, IPS data regarding suspicious activity may be obtained by an IPS system 135 disposed within the network 130 between the client device 105 and the banking server 120. For example, IPS system 135 may be a server within an enterprise environment configured to monitor a group of hosts on a private IP network (including client 105). Similarly, an ISP (internet service provider) may monitor network activity using an IPS system 135. The IPS system 135 may be configured to update IPS database 114 with IP address associated with clients sending/receiving network payloads that indicate some intrusion or exploit is being attempted or that a given IP address has been compromised, e.g., because it is sending/receiving network packets to/from a given address or having payloads matching a particular signature.

For purposes of illustration assume the banking transaction service 125 allows users to view balances online as well as transfer money from one account to a recipient, e.g., using some form of an “online bill pay” service. Further, assume that the client device 125 recently became infected with a man-in-the-browser malware 106. As is known, man-in-the-browser malware generally refers to malicious software that modifies how a web browser operates. For example, malware 106 could recognize a user accessing certain web pages (e.g., an online banking login web page) and change what information is presented to a user, what information is posted to a server from the page, or capture and share information entered by a user (e.g., the value of a user name and password combination). By infecting the user's browser 102 using the “man-in-the-browser” approach, banking server 120 may receive the correct credentials from an authorized machine—allowing the malware 106 to then perform fraudulent transactions under the cover of having originated from a “legitimate” device.

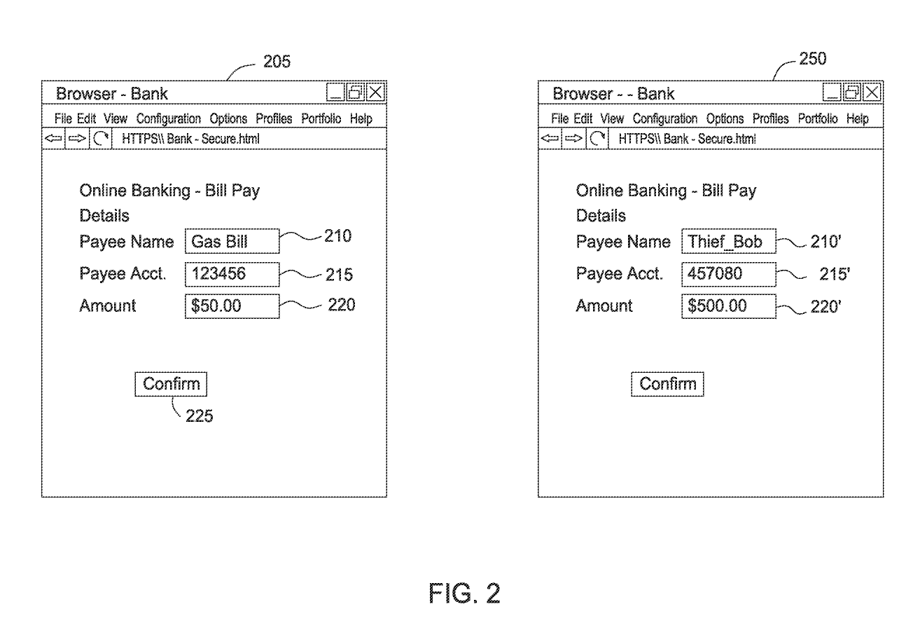

FIG. 2 illustrates an example of a man-in-the-Browser attack, according to one embodiment. Specifically, FIG. 2 shows an example web-form associated with an “online-bill pay” service. In this example, a user is presented with web-form 205, and fills out a payee name 210, account number 215 and an amount 220. Once complete, the user can confirm a transaction using button 225. While the user is presented with the information related to the transaction they intend to perform, and even presented with an indication that the transaction is “secure,” the browser 102 has been modified to alter the contents of form 205 when it is submitted back to the banking server 120. For example, web-form 250 shows the information in form 205 after it is modified by the malware 106. As shown, the malware has modified a payee name 210′, account number 215′ and an amount 220′ to redirect funds to an account associated with a thief. Because the modifications occur inside the cover of a legitimate transaction, the fraud is both difficult to detect beforehand and as well as after the fact. Note, while generally referred to as a “man-in the browser” attack, this approach may be adapted for other applications configured to send/receive data from a network source. For example, a dedicated banking “app” installed on a mobile phone device could be modified in a manner to surreptitiously share login credentials or modify payment instructions initiated using that app.

Referring again to FIG. 1, the authentication service 112 may identify instances of fraudulent activity illustrated in FIG. 2 by correlating recent IPS data from IPS database 114 with a current request to initiate a sensitive transaction. For example, the authentication service 112 may evaluate transactions initiated by the banking application 104 in part, by determining whether IPS database 114 includes an indication of whether any suspicious activity (e.g., a drive-by-download) has recently occurred on the client device 105. In such a case, when a user accesses banking application 104 and provides authorized credentials to engage in a given transaction, the banking server may request the authentication service 112 determine whether the transaction has a high probability of being fraudulent. To do so, the authentication service 112 may evaluate whether a user has supplied the correct credentials, as well as whether the device 105 has been authorized to perform the requested transaction (i.e., is a banking customer using a computing system used in the past to perform online banking transactions). Further, the authentication service 112 may also determine whether the IPS database 114 indicates any suspicious activity has recently occurred on the client device 105 prior to deciding whether the requested transaction carries a high risk of being fraudulent.

In cases where the IPS client 108 is installed on client device 105, a machine ID may be used to uniquely identify that client device 105 in IPS database 114. More specifically, a machine ID can be extracted from client device 105 when the authentication service 112 is evaluating a transaction. If the machine ID appears in the IPS database 114 from a recent time period, the transaction can be blocked or challenged. Note, the time for a “recent period” may be tailored as a matter of preference in a particular case. However, a time period of seven days has proven to be effective in some cases.

In cases where the client device 105 does not have a local IPS client 108, an IP address associated with the client device may be used to identify client device 105 when the authentication service 112 is evaluating a transaction. That is, the authentication service 112 can match an IP address used by client device 105 in initiating a sensitive transaction with IP addresses in the IPS database 114. In case of a match, the authentication service 112 may recommend that the banking transaction service 125 block or otherwise or challenge a transaction. The main advantage of this approach is that it does not require any additional component to be installed on client device 105 by the end user. Specifically, there is no dependency on the existence of the IPS client 108 client, so more users accessing the banking service 125 may be protected. Unlike the machine ID approach, however, the IP address approach may result in a higher false/positive rate, since a single public IP address could represent hundreds of devices in a private IP network.

In still another approach, the web-browser 102 itself may be configured to block certain transactions. For example, a browser plug-in may be configured to recognize that a user has accessed certain web pages, e.g., the banking transaction service 125 may register a number of URLs with a plug-in—such as a URL associated with the form shown in FIG. 2. When a user then attempts to access a registered page, the plug-in can send a machine ID to the authentication service 112 to see whether any records in the IPS database 114 indicate that any suspicious activity has recently occurred on client device 105. Note, in addition to accessing the authentication service 112, in one embodiment, such a browser plug-in could also evaluate a log stored on client device 105 to determine whether IPS client 108 has observed any suspicious network activity occurring on client device 105 during a recent time period.

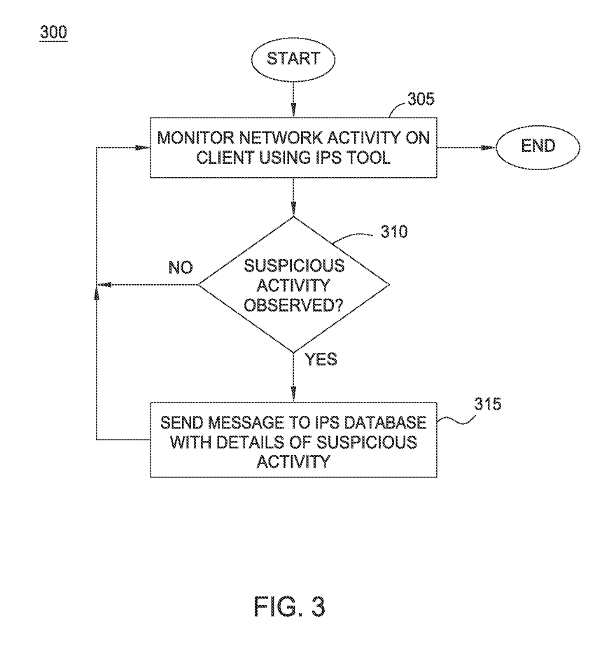

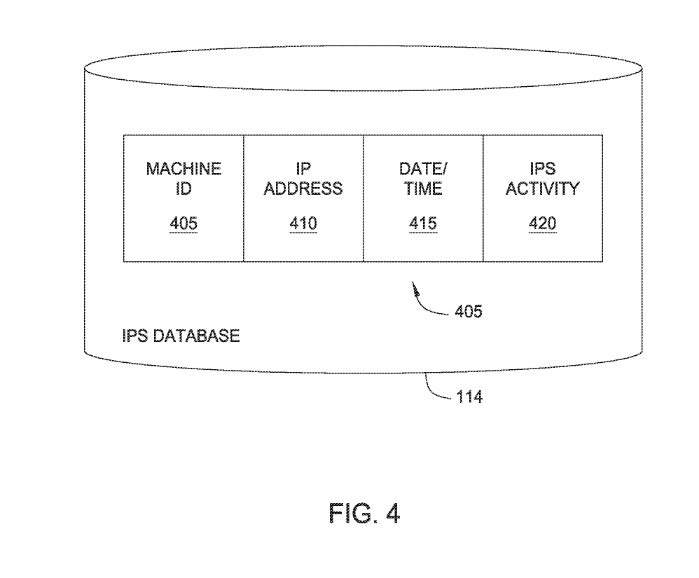

FIG. 3 illustrates a method 300 for an intrusion protection system (IPS) to monitor a host (or hosts), according to one embodiment. As shown, the method 300 begins at step 305 where an IPS tool monitors network activity on a client (or group of clients). For example, as described above, an IPS client 108 may monitor network activity of a particular client device or an IPS system 135 may monitor a group of computing devices on a private IP network. When suspicious activity occurs (decision step 310), the IPS tool may be configured to send a message to an IPS database with details of the observed suspicious activity (step 315). For example, FIG. 4 illustrates an example structure for IPS database records, according to one embodiment. IPS database 114 includes a record 400 for each observed instance of suspicious activity related to network communications to/from a given computing device or host. Illustratively, record 400 indicates a machine ID 405, IP address 410, date/time 415, and a description of the observed suspicious activity. Of course, the actual data captured by a given record may vary from record to record in database 114 and the format and content of records in the IPS database may be tailored to suit the needs of an individual case.

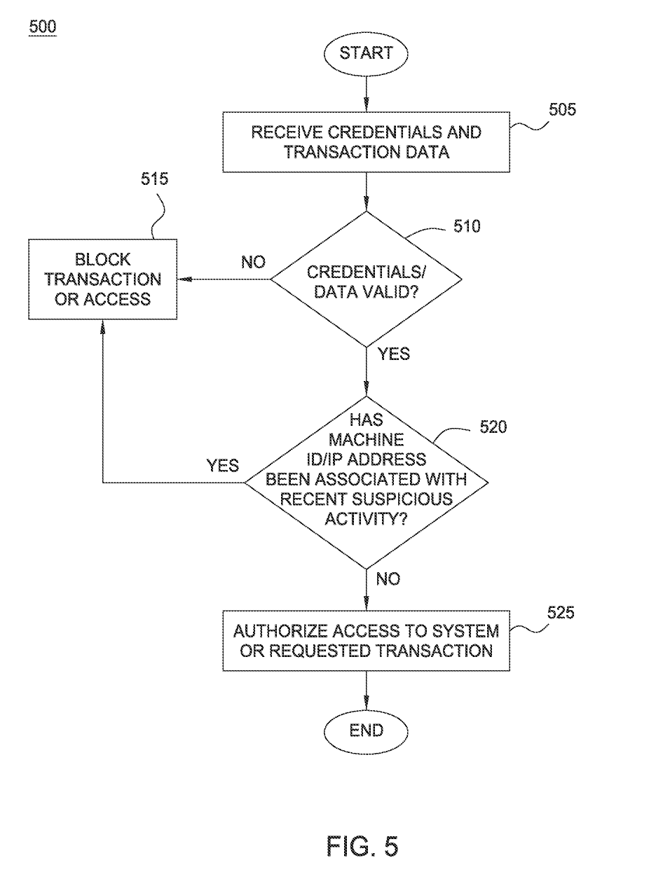

FIG. 5 illustrates a method for detecting online fraud by correlating IPS data with a given authentication or transaction attempt, according to one embodiment. As shown, the method begins at step 505 where an authentication service receives a set of credentials and transaction data associated with a requested transaction. For example, an authentication service 112 may receive a request to evaluate an online banking transaction, prior to authorizing that transaction, to determine whether it represents a high risk of fraud. In one embodiment, the authentication service 112 may evaluate a variety of information related to the transaction, e.g., whether the user supplied the correct credentials, whether the computing device used to initiate the transaction has been authorized by the user (or bank), or whether elements of the transaction itself indicate something unusual (e.g., an usual amount, type, or timing of an online banking transaction). If an anomaly is indicated, or if the incorrect credentials were supplied, then the authentication service may block a requested transaction, prevent access to a network service, or otherwise recommend the transaction be blocked or challenged (step 515).

Otherwise, at step 520, the authentication service may determine whether a machine ID or IP address associated with a transaction under evaluation has been associated with any recent suspicions activity. More specifically, the authentication service may determine whether the machine ID or IP address is in the records of an IPS database, indicating a suspicious event has occurred within a specified time frame (e.g., a time period of seven days prior to the transaction). If the computing device associated with a machine or IP address is present in the IPS database, then the authentication service may recommend that the transaction be blocked or at least challenged for further verification (step 515). If the IPS database does not have any records of suspicious activity on the computing device (represented by machine ID or IP address) occurring within the specified time period, then the authentication service may recommend that access to a system be granted or otherwise indicate that the requested transaction represents a low risk of fraud (based on all available information) and should be allowed to proceed.

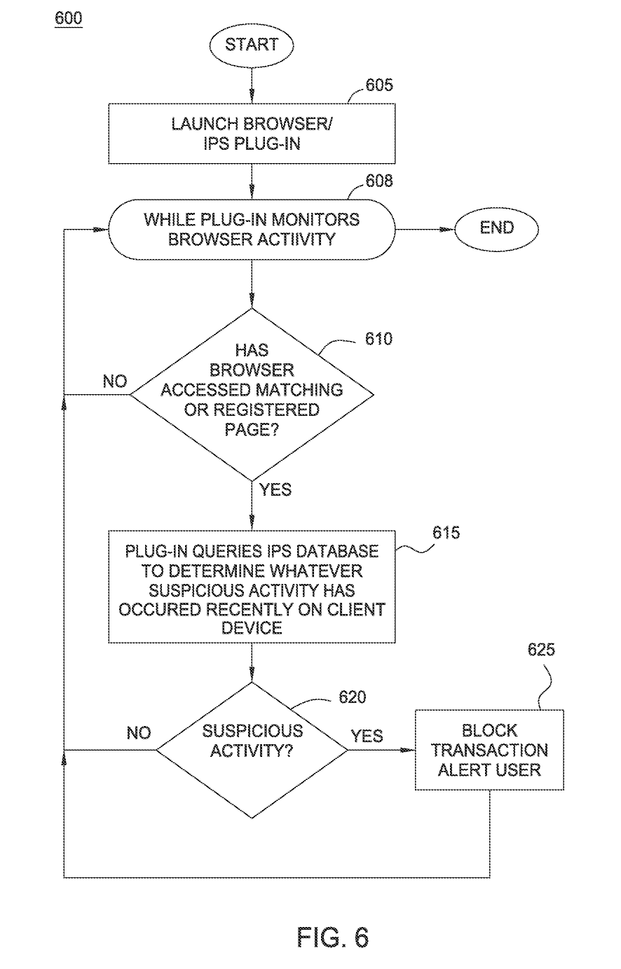

FIG. 6 illustrates an alternative method 600 for detecting online fraud by correlating IPS data with a given authentication or transaction attempt, according to one embodiment. As shown, method 600 begins at step 605 where a user launches a web browser on a computing device along an IPS plug-in. As noted, the IPS plug-in may be configured to monitor for a user accessing certain web-pages. At step 610, while monitoring user browsing activity, the plug-in determines whether the user has accessed a matching or registered page. In one embodiment, the plug-in may be configured with a set of URLs accessed to perform a sensitive transaction. For example, a bank may configure a plug-in with URLs used to log on to an online banking service and initiate financial transactions.

Once the browser accesses a registered web-page, the plug-in may query an IPS database to determine whether any suspicious activity has occurred recently on the client system (step 615). For example, the plug-in may be configured to send a machine ID and/or IP address to an authentication service. In turn, the authentication service may query an IPS database to determine whether any intrusion attempts or other suspicious activity has been reported as occurring on the client system within a specified time period preceding the request to access the registered page. If the plug-in receives a response indicating that the machine ID or IP address is in the IPS database, then the plug-in may prevent the user from accessing the registered page submitting information via a given form, or otherwise engaging in a sensitive transaction (step 615). If no such activity has occurred, then the transaction proceeds and the plug-in may continue to monitor browsing activity.

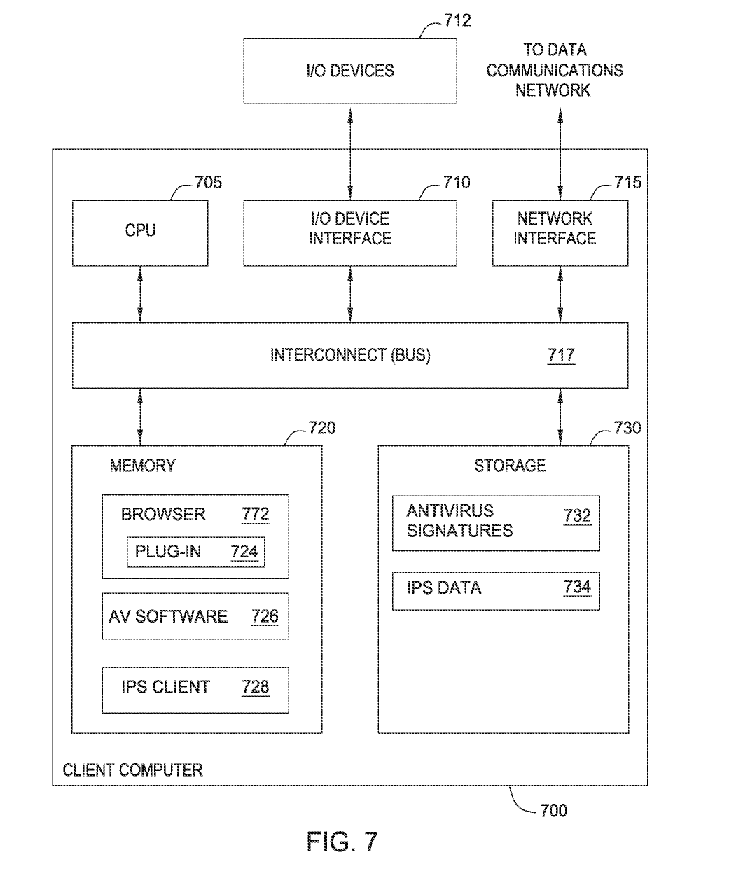

FIG. 7 illustrates an example computing system 700 configured with an IPS tool and browser plug-in, according to one embodiment. As shown, the computing system 700 includes, without limitation, a central processing unit (CPU) 705, a network interface 710, a network interface 705, a memory 720, and storage 730, each connected to a bus 717. The computing system 700 may also include an I/O device interface 710 connecting I/O devices 712 (e.g., keyboard, display and mouse devices) to the computing system 700. Further, in context of this disclosure, the computing elements shown in computing system 700 may correspond to a physical computing system (e.g., a system in a data center) or may be a virtual computing instance executing within a computing cloud.

The CPU 705 retrieves and executes programming instructions stored in the memory 720 as well as stores and retrieves application data residing in the memory 730. The interconnect 717 is used to transmit programming instructions and application data between the CPU 705, I/O devices interface 710, storage 730, network interface 715, and memory 720. Note, CPU 705 is included to be representative of a single CPU, multiple CPUs, a single CPU having multiple processing cores, and the like. And the memory 720 is generally included to be representative of a random access memory. The storage 730 may be a disk drive storage device. Although shown as a single unit, the storage 730 may be a combination of fixed and/or removable storage devices, such as fixed disc drives, removable memory cards, or optical storage, network attached storage (NAS), or a storage area-network (SAN).

Illustratively, the memory 720 includes a browser 722, antivirus software 726, and IPS client 728. The browser 722 itself includes a plug-in 724 used to monitor browsing activity. The storage 730 includes antivirus signatures 732 and IPS data 734. The Antivirus software 726 and IPS client 728 provide software components generally configured to monitor client computer 700 for indications of installed malware components, intrusion attempts, and other malicious or suspicious activity. For example, the IPS client 728 may monitor network payloads, addresses, or other information indicative of malicious activity. When malicious activity is observed, the IPS client 728 may store a record of what is observed in IPS data 734 as well as send records of IPS events to a remote IPS database. Similarly, the antivirus software 726 may scan files on client computer 700 to identify a signature 732 associated with a known malware component. As described, the plug-in 724 may monitor browsing activity to determine when a user is initiating a sensitive transaction, such as logging onto an online banking service or initiating an online financial transaction. When this occurs, the plug-in 724 may determine whether the IPS data 734 has observed any suspicious activity within a specified time period preceding the request to access a given page or initiate a given transaction, and if so, block or otherwise prevent a transaction from occurring.

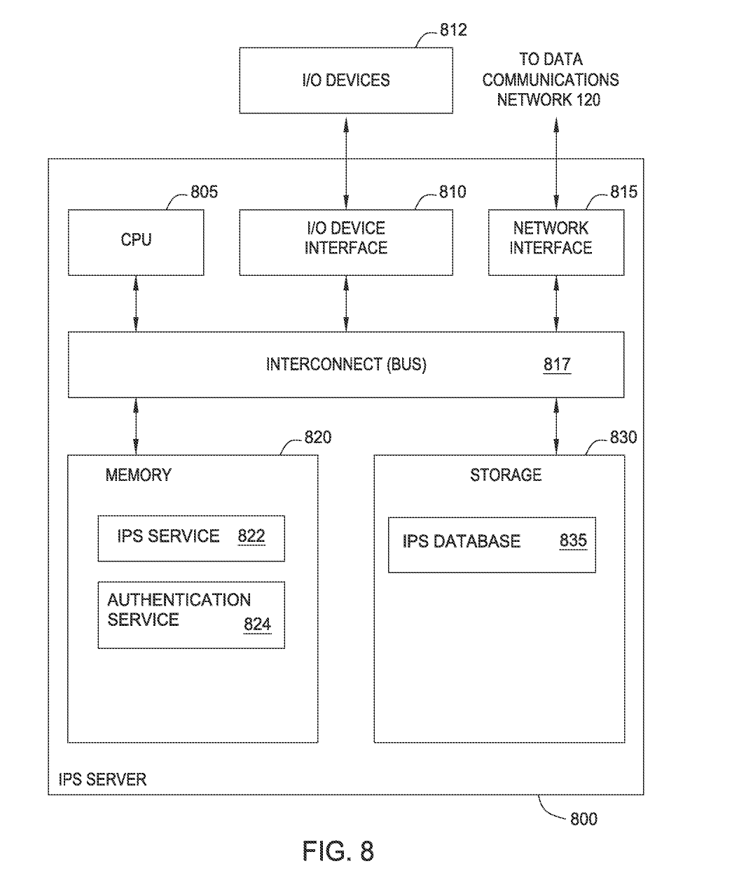

FIG. 8 illustrates an example computing system 800 configured to identify online transactions that have a high fraud risk, according to one embodiment. As shown, the authentication server 800 includes, without limitation, a central processing unit (CPU) 805, a network interface 810, a network interface 805, a memory 820, and storage 830, each connected to a bus 817. The computing system 800 may also include an I/O device interface 810 connecting I/O devices 812 (e.g., keyboard, display and mouse devices) to the computing system 800. Further, in context of this disclosure, the computing elements shown in computing system 800 may correspond to a physical computing system (e.g., a system in a data center) or may be a virtual computing instance executing within a computing cloud.

Like CPU 705, CPU 805 retrieves and executes programming instructions stored in the memory 820 as well as stores and retrieves application data residing in the memory 830. The interconnect 817 is used to transmit programming instructions and application data between the CPU 805, I/O devices interface 810, storage 830, network interface 815, and memory 820. Note, CPU 805 is included to be representative of a single CPU, multiple CPUs, a single CPU having multiple processing cores, and the like. And the memory 820 is generally included to be representative of a random access memory. The storage 830 may be a disk drive storage device. Although shown as a single unit, the storage 830 may be a combination of fixed and/or removable storage devices, such as fixed disc drives, removable memory cards, or optical storage, network attached storage (NAS), or a storage area-network (SAN).

Illustratively, the memory 820 includes an IPS service 822 and authentication service 824. And the storage 836 includes an IPS database 835. As described, the IPS service 835 may provide a software component configured to monitor network activity to/from one or more host systems for signs of intrusion. When such events occur, the IPS service 822 may store a record of the event in IPS database 835. The authentication service 824 may provide a software component configured to evaluate whether a sensitive transaction should proceed. Again, using online banking as a reference example, a banking server may query the authentication service 824 to determine whether a host requesting access to the banking server (or to transfer funds via the server) presents a high risk of being part of a fraudulent transaction. To do so, the authentication service 824 may evaluate whether an IPS database 836 contains a record of the host being part of some recently occurring suspicious activity. As noted, the host may be identified in some cases by a machine ID, e.g., in cases where a local IPS client is installed on the host or by IP address, e.g., in cases where the IPS service 822 is monitoring network communications for a group of hosts for indications of intrusion attempts or other indications of compromise.

As described, embodiments presented herein provide techniques for detecting malware attacks initiated by a host infected with a malicious software application that would otherwise remain undetected by many current fraud detection systems, e.g., for detecting man-in-the-browser Trojans. In one embodiment, a fraud detection system operates in conjunction with an IPS system to identify online transactions that have a high probability of being fraudulent or initiated by a legitimate, but compromised host. The combined approach allows a financial services company (e.g., a bank, brokerage, etc.) to better vet transactions in real time. More generally, adding a malware-detection-based security layer as part of a process for performing sensitive transactions may significantly improve the likelihood of detecting fraud and unauthorized access transactions, while also providing a solution to man-in-the-browser attacks, which go undetected by currently available authentication solutions.

While the foregoing is directed to embodiments of the present invention, other and further embodiments of the invention may be devised without departing from the basic scope thereof, and the scope thereof is determined by the claims that follow.

What is claimed is:

1. A computer-implemented method for detecting attempts at online fraud or unauthorized access to a computing system, the method comprising:
receiving, from a computing device, a request to perform a transaction;
prior to the transaction being performed, determining whether an intrusion prevention system (IPS) has a record of an intrusion attempt occurring on the computing device within a predefined time period prior to receiving the request to perform the transaction; and
upon determining the IPS has a record of an intrusion attempt occurring on the computing device within the predefined time period, responding to the request with an indication that the transaction should be challenged.

2. The method of claim 1, wherein the computing device includes an IPS client configured to monitor network communications on the computing device, and wherein the IPS client generates records stored by the IPS system identifying the computing device using a machine identifier (ID).

3. The method of claim 1, wherein the IPS system monitors network communications to/from the computing device, and wherein the IPS system generates records stored by the IPS system which identify the computing device using a network address.

4. The method of claim 1, further comprising, upon determining the IPS does not have a record of an intrusion attempt occurring on the computing device within the predefined time period, responding to the request with an indication that the transaction should proceed.

5. The method of claim 1, wherein the transaction is a logon request to access an online service.

6. The method of claim 1, further comprising, prior to determining whether the intrusion prevention system (IPS) has a record of an intrusion attempt occurring on the computing device:
receiving a set of user credentials associated with a user of the computing device; and
validating the credentials.

7. The method of claim 1, wherein the intrusion attempt comprises an attempt to install a man-in-the-browser Trojan on the client device.

8. A computer-readable storage medium storing instructions, which, when executed on a processor, perform an operation for detecting attempts at online fraud or unauthorized access to a computing system, the operation comprising:
receiving, from a computing device, a request to perform a transaction;
prior to the transaction being performed, determining whether an intrusion prevention system (IPS) has a record of an intrusion attempt occurring on the computing device within a predefined time period prior to receiving the request to perform the transaction; and
upon determining the IPS has a record of an intrusion attempt occurring on the computing device within the predefined time period, responding to the request with an indication that the transaction should be challenged.

9. The computer-readable storage medium of claim 8, wherein the computing device includes an IPS client configured to monitor network communications on the computing device, and wherein the IPS client generates records stored by the IPS system identifying the computing device using a machine identifier (ID).

10. The computer-readable storage medium of claim 8, wherein the IPS system monitors network communications to/from the computing device, and wherein the IPS system generates records stored by the IPS system which identify the computing device using a network address.

11. The computer-readable storage medium of claim 8, wherein the operation further comprises, upon determining the IPS does not have a record of an intrusion attempt occurring on the computing device within the predefined time period, responding to the request with an indication that the transaction should proceed.

12. The computer-readable storage medium of claim 8, wherein the transaction is a logon request to access an online service.

13. The computer-readable storage medium of claim 8, wherein the operation further comprises, prior to determining whether the intrusion prevention system (IPS) has a record of an intrusion attempt occurring on the computing device:
receiving a set of user credentials associated with a user of the computing device; and
validating the credentials.

14. The computer-readable storage medium of claim 8, wherein the intrusion attempt comprises an attempt to install a man-in-the-browser Trojan on the client device.

15. A system, comprising:
a processor and
a memory hosting an application, which, when executed on the processor, performs an operation for detecting attempts at online fraud or unauthorized access to a computing system, the operation comprising:
receiving, from a computing device, a request to perform a transaction,
prior to the transaction being performed, determining whether an intrusion prevention system (IPS) has a record of an intrusion attempt occurring on the computing device within a predefined time period prior to receiving the request to perform the transaction, and
upon determining the IPS has a record of an intrusion attempt occurring on the computing device within the predefined time period, responding to the request with an indication that the transaction should be challenged.

16. The system of claim 15, wherein the computing device includes an IPS client configured to monitor network communications on the computing device, and wherein the IPS client generates records stored by the IPS system identifying the computing device using a machine identifier (ID).

17. The system of claim 15, wherein the IPS system monitors network communications to/from the computing device, and wherein the IPS system generates records stored by the IPS system which identify the computing device using a network address.

18. The system of claim 15, wherein the operation further comprises, upon determining the IPS does not have a record of an intrusion attempt occurring on the computing device within the predefined time period, responding to the request with an indication that the transaction should proceed.

19. The system of claim 15, wherein the transaction is a logon request to access an online service.

20. The system of claim 15, wherein the operation further comprises, prior to determining whether the intrusion prevention system (IPS) has a record of an intrusion attempt occurring on the computing device:
receiving a set of user credentials associated with a user of the computing device; and
validating the credentials.

21. The system of claim 15, wherein the intrusion attempt comprises an attempt to install a man-in-the-browser Trojan on the client device.
